(19) United States
(12) Patent Application Publication
(10) Pub. No.: US 2025/0247647 A1
(43) Pub. Date: Jul. 31, 2025

(54) SYSTEMS AND METHODS FOR SUBBAND ADAPTIVE FILTERING FOR ENHANCED ACTIVE NOISE CANCELLATION IN VEHICLES

(71) Applicant: Harman International Industries, Incorporated, Stamford, CT (US)

(72) Inventors: Tao Feng, Novi, MI (US); Geon-Seok Kim; Michael Hinz, North Vancouver (CA)

(21) Appl. No.: 19/017,197

(22) Filed: Jan. 10, 2025

Related U.S. Application Data
(60) Provisional application No. 63/627,632, filed on Jan. 31, 2024.

(51) Int. Cl. H04R 3/02

(52) U.S. Cl. CPC H04R 3/02; H04R 2499/13

(57) ABSTRACT

The present disclosure relates to systems and methods for enhancing active noise cancellation (ANC) in vehicles, particularly for addressing the challenges associated with broadband noise control. The disclosure introduces a novel approach to subband adaptive filtering (SAF) that significantly reduces computational load and improves noise cancellation across a wide frequency spectrum. The noise cancellation system comprises a reference sensor, adaptive weight filter, speakers, error microphones, signal processing unit, subband processing module, gradient determination module, adaptive step size determination module, subband adaptive weight update module, and weight transformation module. The disclosed approaches enable implementation of ANC in environments with limited processing power without sacrificing performance, by reducing complexity and improving convergence speed and stability of the adaptive filter weights.

### CROSS REFERENCE TO RELATED APPLICATIONS

The present application claims priority to U.S. Provisional Application No. 63/627,632, entitled “SYSTEMS AND METHODS FOR SUBBAND ADAPTIVE FILTERING FOR ENHANCED ACTIVE NOISE CANCELLATION IN VEHICLES”, and filed on Jan. 31, 2024. The entire contents of the above-listed application are hereby incorporated by reference for all purposes.

### TECHNICAL FIELD

The present disclosure generally relates to active noise cancellation (ANC) systems, and more particularly to enhancing the performance of ANC systems in various environments, such as automotive applications.

### BACKGROUND AND SUMMARY

Active noise cancellation (ANC) technology is a method used to reduce unwanted sound by introducing a second sound specifically designed to cancel the first. This technology is widely used in various applications, including headphones, residential and commercial buildings, and automotive environments, to create a quieter and more comfortable acoustic experience. In automotive applications, ANC systems are particularly beneficial for reducing road noise, engine noise, and other external sounds that can penetrate the cabin of a vehicle, thereby enhancing the comfort of passengers.

Traditional ANC systems often employ a filtered-x least mean square (FX-LMS) algorithm, which is effective in a narrow frequency range but faces challenges when dealing with broadband noise, such as road noise in vehicles. The FX-LMS algorithm operates in the time domain and requires substantial computational power, which can be a limiting factor in real-time applications. Moreover, the performance of the FX-LMS algorithm tends to degrade in the presence of wide frequency noise due to its inherent limitation in minimizing the overall noise level across a broad frequency spectrum, particularly at higher frequencies where the algorithm struggles to maintain effective noise attenuation.

To address these limitations, subband adaptive filter (SAF) algorithms were introduced, which partition the wide frequency range into multiple subbands, allowing for more targeted noise cancellation and reduced computational load compared to the time-domain FX-LMS algorithm. However, conventional SAF algorithms still demand significant computational resources, as they apply secondary path filtering to the wideband signal through convolution, which is computationally intensive. The challenge is further exacerbated in electric vehicles (EVs), where the absence of engine noise accentuates road noise. The quiet electric powertrain of EVs lacks the masking effect provided by internal combustion engines, thus requiring ANC systems to address a wider range of frequencies and adapt to the unique acoustic profile of EVs. Recognizing the above issues, the inventors herein have developed ANC solutions that can effectively cancel road noise across a broad frequency spectrum while improving computational efficiency, particularly in the field of electric vehicle technology.

The present application provides systems and methods for in-vehicle noise cancellation that significantly enhances the performance of active noise cancellation (ANC) systems, particularly in automotive environments where broadband noise control is challenging. The application introduces an approach to subband adaptive filtering (SAF) that addresses the computational limitations of traditional ANC systems and improves the cancellation of noise across a wide frequency spectrum.

In a first aspect, a method for noise cancellation in a vehicle having a reference sensor configured to acquire a reference signal correlated to noise within a vehicle cabin, a plurality of speakers positioned within the vehicle cabin configured to emit a noise cancellation signal, and a plurality of error microphones positioned within the vehicle cabin recording a residual signal, includes processing the reference signal with an adaptive weight filter to produce a noise cancellation signal, applying a set of analysis filters to decompose the residual signal into a plurality of subband error signals and to decompose the reference signal into a plurality of subband reference signals, applying a respective subband secondary path transfer function to each subband reference signal to produce a plurality of filtered subband reference signals, determining a subband gradient for each subband based on a respective filtered subband reference signal and a respective subband error signal, determining an adaptive step size for updating subband adaptive filter weights for each of a plurality of subband adaptive filters, updating a plurality of adaptive filter weights in each of the plurality of subband adaptive filters based on a respective adaptive step size and gradient, and integrating the plurality of adaptive filter weights in each of the plurality of subband adaptive filters to produce updated weights for the adaptive weight filter, wherein the updated weights are applied to the adaptive weight filter to adjust the noise cancellation signal.

The above method provides several computational advantages by applying the secondary path transfer function to each subband separately, as well as by utilizing an adaptive step size to improve the convergence speed and stability of the adaptive filter weights. First, the method significantly reduces the computational load required for ANC systems. Traditional full-band secondary path filtering processes are computationally intensive due to the necessity of convolving the wideband signal with the secondary path filter. By partitioning the signal into multiple subbands and applying the secondary path filter within each subband, the method reduces the computational complexity from O(N²) to O((N/m)²m), where N is the filter length and m is the number of subbands. This reduction in computational load is substantial; for example, a wideband process using a filter length of 256 requires 65,536 computations, whereas processing the same signal in 16 subbands requires only 4,096 computations, which is 6% of the full-band computation. This reduction enables the implementation of the ANC system in environments with limited processing power, such as automotive applications, without sacrificing performance. Second, the method introduces an adaptive step size normalization within each subband, which enhances the performance and convergence rate of the subband adaptive filter weights. This method not only accelerates the convergence of the adaptive filter weights but also contributes to the stability of the ANC system. By dynamically adjusting the step size, the adaptive filter weights quickly adapt to changes in the noise environment while maintaining robust noise cancellation performance.

Furthermore, the above approach to calculating the subband secondary path eliminates the need for traditional impulse response (IR) measurement techniques, which are often challenging to implement in practice. The direct calculation of the subband secondary path simplifies the setup process and further reduces computational requirements.

In a second aspect, a noise cancellation system for a vehicle, includes a reference sensor configured to acquire a reference signal correlated to noise within a vehicle cabin, an adaptive weight filter in electronic communication with the reference sensor, configured to apply an adaptive filtering process to the reference signal to produce a noise cancellation signal, a plurality of speakers positioned within the vehicle cabin and in electronic communication with the adaptive weight filter, configured to emit the noise cancellation signal into the vehicle cabin, a plurality of error microphones positioned within the vehicle cabin and configured to record a residual signal resulting from interaction of the emitted noise cancellation signal and the noise within the vehicle cabin, and a signal processing unit in electronic communication with the reference sensor and the plurality of error microphones, wherein the signal processing unit comprises a non-transitory memory storing a set of subband filters, and instructions, and a processor, wherein, when executing the instructions, the processor is configured to decompose the residual signal into a plurality of subband error signals and to decompose the reference signal into a plurality of subband reference signals, convert the plurality of subband reference signals and the plurality of subband error signals into a plurality of subband reference signal blocks and a plurality of subband error signal blocks, respectively, transform the plurality of subband error signal blocks and the plurality of subband reference signal blocks into a plurality of frequency-domain subband error signals and a plurality of frequency-domain subband reference signals, respectively, apply a frequency-domain secondary path filter to the plurality of frequency-domain subband reference signals to produce a plurality of frequency-domain subband filtered reference signals, determine a frequency-domain subband gradient for each subband based on a respective frequency-domain subband filtered reference signal and a corresponding frequency-domain subband error signal, determine an adaptive step size for updating frequency-domain subband adaptive filter weights for each of a plurality of frequency-domain subband adaptive filters, update a plurality of frequency-domain adaptive filter weights in each of the plurality of frequency-domain subband adaptive filters based on a respective frequency-domain adaptive step size and frequency-domain subband gradient, and integrate the plurality of frequency-domain adaptive filter weights in each of the plurality of frequency-domain subband adaptive filters to produce updated weights for the adaptive weight filter in a time domain, wherein the updated weights are applied to the adaptive weight filter to adjust the noise cancellation signal.

The above noise cancellation system leverages the computational efficiency of frequency-domain processing by converting the residual signals and reference signals into the frequency-domain using a Fast Fourier Transform (FFT) and applying a frequency-domain secondary path filter, which enables substantial computational benefits over traditional time-domain methods. By processing the adaptive filter weights in the frequency domain, the system significantly reduces the computational complexity from O(N²) to O(N log₂(N)), where N is the filter length. This reduction is particularly impactful when considering the high computational demands of real-time ANC in a vehicle environment, where the system must rapidly adapt to a wide range of noise frequencies and intensities.

Moreover, the system's use of subband signal processing, facilitated by a set of analysis filters allows for targeted noise cancellation across different frequency bands. This not only enhances the precision of the ANC but also minimizes the computational load by focusing resources on the frequency bands most affected by noise. The frequency-domain gradient determination and adaptive step size determination modules further adjust the filter adaptation process, improving convergence performance of the adaptive filter weights. In addition to computational efficiency, the system also addresses practical challenges such as the wrap-around effect, commonly encountered in frequency-domain ANC systems. By employing a subband overlap-save method, the system ensures linear convolution in the frequency domain, thereby avoiding the detrimental effects of circular convolution on ANC performance.

In a third aspect, a method for noise cancelling includes, acquiring a reference signal using a reference sensor, wherein the reference signal is correlated with noise in a vehicle cabin, emitting a noise cancellation signal using a plurality of speakers positioned in the vehicle cabin, acquiring a residual signal from a plurality of error microphones positioned in the vehicle cabin, transforming the reference signal and the residual signal into a frequency-domain reference signal and a frequency-domain residual signal, respectively, using a Fast Fourier Transform (FFT), applying a secondary path filter to the frequency-domain reference signal to produce a frequency-domain filtered reference signal, decomposing the frequency-domain filtered reference signal and the frequency-domain residual signal into a plurality of subband signals, calculating a frequency-domain subband gradient for each subband based on the decomposed frequency-domain filtered reference signal and the frequency-domain residual signal, updating a set of subband adaptive filter weights in a frequency domain based on the frequency-domain subband gradient and a frequency-domain subband flexible adaptation step size normalization, transforming the updated set of subband adaptive filter weights from the frequency domain to a time domain using an Inverse Fast Fourier Transform (IFFT), and emitting the noise cancellation signal based on the transformed subband adaptive filter weights to reduce noise in the vehicle cabin.

The above method for noise cancellation presents several advantages that significantly enhance the performance and efficiency of ANC systems in vehicle cabins. By utilizing an FFT to transform both the reference and residual signals into the frequency domain, the method enables a more computationally efficient approach to noise cancellation. This transformation allows for the application of a secondary path filter and subband filters directly in the frequency domain, which simplifies the process of producing a plurality of frequency-domain subband filtered reference signals. Moreover, the incorporation of frequency-domain subband flexible adaptation step size normalization further refines the weight adjustment process, leading to improved convergence speed and noise cancellation performance.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which some embodiments described herein pertain. Although methods and materials similar to or equivalent to those described herein can be used in the practice or testing of embodiments described herein, exemplary methods and/or materials are described below. In case of conflict, the patent specification, including definitions, will control. In addition, the materials, methods, and examples are illustrative and are not intended to be necessarily limiting.

Implementation of the method and/or system of some embodiments described herein can involve performing or completing selected tasks automatically. Moreover, according to actual instrumentation and equipment of embodiments of the method and/or system described herein, several selected tasks could be implemented by hardware, by software or by firmware or by a combination thereof using an operating system.

For example, hardware for performing selected tasks according to some embodiments described herein could be implemented as a chip or a circuit. As software, selected tasks according to embodiments described herein could be implemented as a plurality of software instructions being executed by a computer using any suitable operating system. In an exemplary embodiment described herein, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

FIG. 1 illustrates a schematic diagram of an active noise cancelling system, according to an embodiment of the current disclosure;

FIG. 2 includes four graphs showing a performance comparison between the traditional FXLMS algorithm and the proposed subband adaptive filter algorithm with subband secondary path;

FIG. 3 is a schematic of a Subband Adaptive Filter Algorithm with Subband Secondary Path according to one or more embodiments of the present application;

FIG. 4 is a schematic of Subband Secondary Path Calculation according to one or more embodiments of the present application;

FIG. 5 includes four graphs showing a performance comparison between the traditional FXLMS algorithm and the proposed time-frequency subband adaptive filter (TF-SAF) algorithm;

FIG. 6 is a schematic of the Time-Frequency Subband Adaptive Filter (TF-SAF) Algorithm according to one or more embodiments of the present application;

FIG. 7 includes four graphs showing a performance comparison between the traditional FXLMS algorithm and the proposed SFXLMS algorithm;

FIG. 8 is a schematic of the Subband FXLMS (SFXLMS) Algorithm according to one or more embodiments of the present application.

The drawings are for illustrative purposes only and may not be to scale. The embodiments depicted in the drawings are not intended to limit the scope of the application as defined by the claims.

### DETAILED DESCRIPTION

Embodiments of the present application are described in detail below, and examples of the embodiments are illustrated in the accompanying drawings, wherein the same or similar reference numerals indicate the same or similar components or components having the same or similar functions. The embodiments described below by reference to the accompanying drawings are exemplary and are intended only to explain the present application and are not to be construed as limiting the present application.

In a first aspect, the current disclosure relates to a novel subband adaptive filtering (SAF) algorithm for active noise cancellation (ANC), particularly for road noise cancellation (RNC) in electric vehicles. The disclosed approach addresses the limitations of the conventional filtered-x least mean square (FXLMS) algorithm, which struggles with high-frequency noise cancellation and requires significant computational power. The disclosed SAF algorithm with subband secondary path (SSP) computation offers a solution that maintains performance while significantly reducing computational load.

The SAF algorithm disclosed herein partitions the full band signal into multiple subbands, thereby transforming the computationally intensive process of secondary path filtering into a more manageable task. This is achieved by applying secondary path filters within each subband, which are difficult to obtain through traditional impulse response measurement techniques. The application introduces a new subband secondary path calculation technique that eliminates the need for impulse response measurement, allowing for direct calculation of the subband secondary path.

In the context of RNC systems, the conventional FXLMS algorithm minimizes the overall noise level across a wide frequency range, which can compromise cancellation performance, particularly for high-frequency interior noise. The SAF algorithm, originally introduced by D. R. Morgan in 1995, improved upon the FXLMS algorithm by reducing computational load and enhancing wide frequency noise cancellation performance. However, the SAF algorithm still demanded a higher computational power than the time-frequency domain FX-LMS algorithm. The present application overcomes this challenge by introducing a subband approach to the secondary path filtering process.

The disclosed SAF algorithm utilizes a set of subband analysis filters derived from a prototype filter, such as a window-based lowpass filter using Hamming or Kaiser windows. The impulse response of each subband filter is calculated, and the input signal is partitioned into individual subbands accordingly. The subband reference signals and subband error signals are then computed through a signal subband and decomposition process.

To calculate the subband filtered reference signal on each subband, the subband secondary path is applied. This approach significantly reduces the computational cost associated with time-domain secondary path convolution. For example, if a 256 filter length is used in wideband processing, it requires 65,536 computations for secondary path filtering. However, processing the same signal in 16 subbands reduces the computational load to 4,096, which is only 6% of the full band computation.

The current disclosure further introduces subband flexible adaption step size normalization to enhance the SAF algorithm's performance and convergence rate. This method adjusts the step size based on the power contribution of the error microphone signal and the reference signal. The subband adaptive filter weights are then calculated and updated based on the subband gradient and normalized step size.

To obtain the full length of the adaptive filter in the time-domain, a subband weight transformation process is employed. This process transfers all subband adaptive filters to full-length adaptive filters, allowing for the effective implementation of the SAF algorithm in RNC systems.

The subband secondary path calculation can be performed either online or offline. The method utilizes white noise as the reference signal to estimate the transfer function from one speaker to multiple error microphones in a Single Input Multiple Output (SIMO) system. This approach simplifies the computation of the subband secondary path, further reducing computational complexity.

Simulation results demonstrate that the new SAF algorithm with SSP achieves significant improvements in performance compared to traditional RNC algorithms, particularly in the high-frequency range.

In a second aspect, the current disclosure relates to a novel time-frequency subband adaptive filter (TF-SAF) approach for ANC systems, particularly beneficial for reducing undesirable, droning, road-induced interior noise in vehicles. The TF-SAF approach herein disclosed updates the subband adaptive filters on a block-by-block basis in the frequency-domain, rather than sample-by-sample in the time-domain as in conventional SAF algorithms. This frequency-domain approach significantly reduces computational complexity and cost, as it avoids the excessive computational load associated with time-domain processing.

In the TF-SAF approach herein disclosed, the input signal is partitioned into individual subbands using a set of subband analysis filters derived from a prototype filter. The prototype filter is designed using window-based lowpass filter techniques, with window functions such as Hamming or Kaiser windows selected based on the intended application. The impulse response of each subband filter, is calculated using the equation provided in the disclosure, where M is the number of subbands and lsw is the length of the subband analysis filter.

The residual signal e(n) is obtained by expressing it as a function of the primary signal on the error microphone, the real impulse response of the secondary path from the speaker to the error microphone, the reference signal, and the full-length adaptive filter Wₖᵢ(n), as described herein. The linear convolution operator is used to calculate the residual signal. The subband reference and error signals are calculated through a signal subband and decomposition process, which is based on the subband analysis filter. The subband reference signal and the subband error signal are computed as described herein, with the subband index K determined by the iteration n and the decimation factor D.

To address the wrap-around effect encountered in frequency-domain processing, the subband overlap-save method is applied to the TF-SAF algorithm. This method employs a signal block process for both subband reference signals and subband error signals, which are then transformed into the frequency-domain using the Fast Fourier Transform (FFT). The frequency-domain secondary path is applied to reduce computational load further. It is used to calculate the subband filtered reference signal for each subband, as detailed herein. The frequency-domain subband gradient is then expressed as a function of the frequency-domain subband filtered reference signal and the frequency-domain subband error signal.

To enhance the convergence speed and performance of the TF-SAF algorithm, a frequency-domain subband flexible adaption step size normalization method is proposed. This method adjusts the step size based on the power contribution of the error microphone signal and the reference signal. The normalized step size in the frequency-domain is calculated using the sum power for filtered reference signal and error signal on the m^{th} subband, as well as other parameters detailed herein. The frequency-domain subband adaptive filter weight is updated based on the frequency-domain subband gradient and the frequency-domain normalized step size. The subband weight transformation process is then used to transfer frequency-domain subband adaptive filters to time-domain full-length adaptive filters. Simulation results have demonstrated that the proposed TF-SAF algorithm offers significant improvements across the broadband frequency range, particularly in the high-frequency range, while also reducing computational cost relative to traditional time-domain SAF algorithms.

In a third aspect, the current disclosure relates to a novel and computationally efficient subband filtered-x least mean squares (SFXLMS) approach for ANC systems, particularly suitable for broadband noise control in various environments, such as vehicle interiors. The application addresses the problem of excessive computational complexity associated with current SAF algorithms, which are based on a time-domain structure and require sample-by-sample updates of all subband adaptive filters. The current disclosure also improves upon the limitations of the FX-LMS algorithm, which struggles with wide frequency noise cancellation due to the varying primary noise spectrum across a wide frequency range.

The disclosed SFXLMS algorithm features a frequency domain filter bank that utilizes the Fast Fourier Transform (FFT) algorithm instead of the time-domain frequency shift technique. This approach significantly reduces the computational load by processing the w-filter update convolution in the frequency domain via FFT, thereby avoiding the computationally intensive convolution process required by the current SAF algorithm. The application further simplifies the algorithmic structure by eliminating the need for subband analysis filters to perform subband filtering. In practical terms, the current disclosure replaces the traditional subband filtering process with a more efficient FFT process. This results in a substantial reduction in computational load for the full band SAF by processing the w-filter update convolution in the frequency domain. Additionally, the approach taught in the current disclosure removes the computationally heavy time-domain secondary path convolution process, replacing it with a method of multiplying frequency domain reference sensor signals with the secondary path in each band.

The convergence speed of the proposed technique is slightly lower than that of the current SAF, but it still provides comparable cancellation performance with a fraction of the computational load. For example, when using a filter length of 32 for w-filter updates in each band, traditional convolution would require 1,024 computations. In contrast, processing the same signal via FFT requires only 160 computations, which is merely 6.4% of that required by convolution. This efficiency extends to the computation load for secondary path convolution, which, in the conventional algorithm, requires 65,536 multiplications when the filter length is 256, while in the current disclosure this may be reduced to only 256 multiplications.

The SFXLMS approach is particularly advantageous for Road Noise Cancellation (RNC) systems, which aim to reduce undesirable, droning, road-induced interior noise. Simulation results demonstrate that the SFXLMS algorithm offers significant improvements across the broadband frequency range compared to traditional RNC algorithms, with a notable increase of 2.4 dB in the high-frequency range.

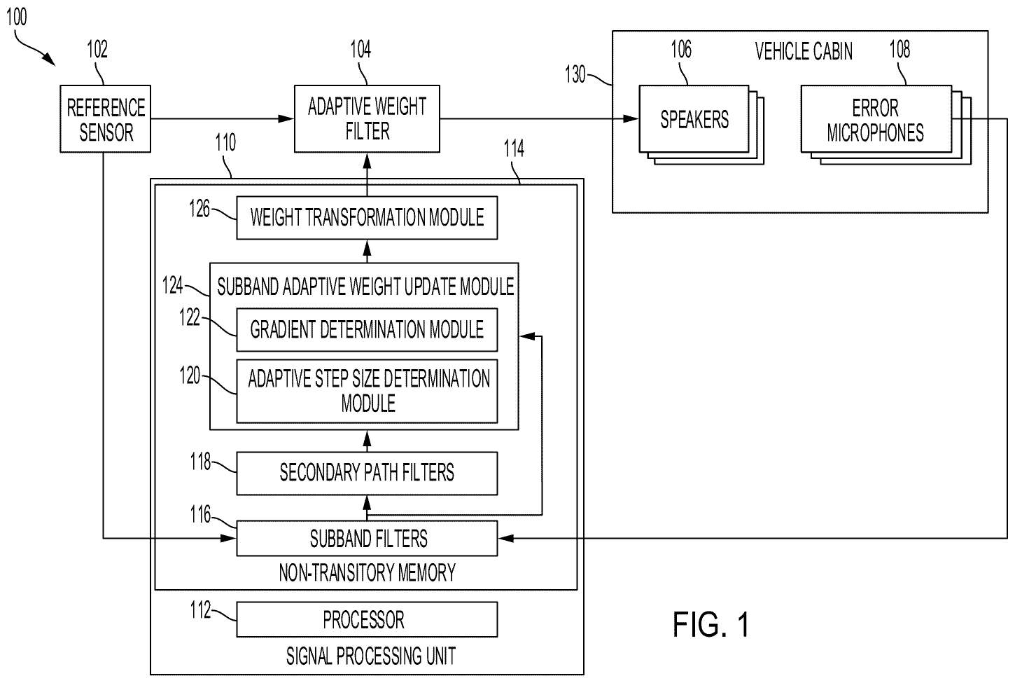

Referring to FIG. 1, a block diagram of a vehicle noise cancelling system 100 is depicted. The vehicle noise cancelling system 100 is configured to enhance the acoustic environment within a vehicle cabin 130 by actively reducing unwanted noise. The system 100 is equipped with a reference sensor 102, which is tasked with acquiring a reference signal that correlates with the noise present within the vehicle cabin 130. This reference signal serves as the basis for generating a noise cancellation signal that counteracts the detected noise.

Noise cancelling system 100 comprises an adaptive weight filter 104, which processes the reference signal obtained by the reference sensor 102 and applies an adaptive filtering algorithm to produce the noise cancellation signal. The adaptive weight filter 104 is configured to adjust its filtering characteristics dynamically to reduce a residual signal acquired via a plurality of error microphones 108.

The noise cancelling system 100 includes a plurality of speakers 106 strategically positioned within the vehicle cabin 130. These speakers 106 are configured to emit the noise cancellation signal into the cabin space, thereby creating an anti-noise sound field that interferes with the unwanted noise to reduce or eliminate it. To monitor the effectiveness of the noise cancellation process, a plurality of error microphones 108 are also positioned within the vehicle cabin 130. These error microphones 108 capture the residual signal, which is the resultant sound after the interaction of the emitted noise cancellation signal with the original noise. The residual signal provides feedback on the performance of the noise cancelling system 100.

The signal processing unit 110 serves as the computational hub of the noise cancelling system 100. It is in electronic communication with both the reference sensor 102 and the error microphones 108. The signal processing unit 110 houses a processor 112 and a non-transitory memory 114, which together execute machine-readable instructions for cancelling noise within vehicle cabin 130. The processor 112 in the signal processing unit 110 is a hardware component designed to execute machine executable instructions stored in non-transitory memory 114, including instructions for computational tasks for real-time signal processing, including adaptive filtering algorithms, subband decomposition, and gradient calculations for filter weights. The processor 112 processes data to generate a real-time noise cancellation signal that counteracts unwanted noise in the vehicle cabin 130.

The non-transitory memory 114 stores machine-readable instructions and data for the noise cancelling system 100, maintaining this information even when the system is off. It contains firmware, software, and data structures or databases used by the processor 112, and may consist of ROM, flash memory, or other non-volatile storage technologies. The memory 114 also holds historical data and adaptive filter coefficients for system learning and performance enhancement.

In the signal processing unit 110 of the vehicle noise cancelling system 100, the set of subband filters 116 is used in the decomposition of audio signals into multiple frequency subbands. The subband filters 116 are designed to divide the broad frequency range of the reference and residual signals into narrower frequency bands. Each filter within the set targets a specific segment of the frequency spectrum, enabling the system 100 to implement noise cancellation strategies that are suitable for the acoustic properties of each subband. The design of the subband filters 116 includes a prototype filter, which in some embodiments may comprise a lowpass filter with a pre-determined window function. The selection of the window function, such as Hamming or Kaiser, depends on the desired frequency response characteristics and the balance between the width of the main lobe and the attenuation of side lobes in the filter's frequency response. The prototype filter is then modulated to create a series of bandpass filters that span the frequency range of interest.

The impulse response of each subband filter, denoted as hₘ, is obtained from the prototype filter by a modulation process that shifts the filter's passband to the target subband's frequency range. The impulse response for the m^{th} subband filter is determined using a mathematical transformation that includes the effects of modulation and windowing. The number of subbands, M, and the length of each subband filter, l_{sw}, are parameters that affect the resolution and computational requirements of the subband filtering process. The subband filters 116 are utilized on the reference and residual signals through filter bank analysis. This involves convolving the input signals with the impulse responses of each subband filter to isolate the subband components. The outputs are sets of subband reference signals and subband error signals, which reflect the frequency content of the original signals within each subband. By operating in the subband domain, the noise cancelling system 100 can more effectively tackle the noise cancellation task by focusing on specific frequencies. This method reduces the computational demands compared to full-band processing and improves the system's capability to adjust to varying noise conditions within the vehicle cabin.

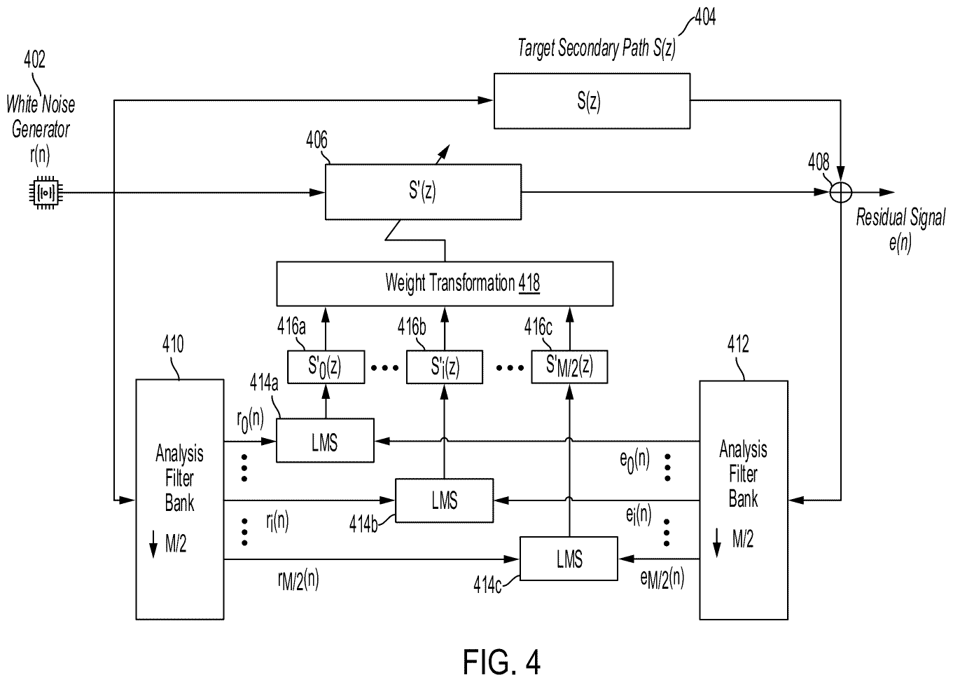

Secondary path filters 118 are applied to the subband reference signals to produce filtered subband reference signals. These secondary path filters 118 model the acoustic transfer function from the speakers 106 to the error microphones 108 within each subband. These filters reflect the characteristics of the vehicle cabin's acoustic environment, which includes cabin geometry, upholstery materials, and the variable presence of passengers or cargo. Each secondary path filter in secondary path filters 118 corresponds to a particular subband and processes the associated subband reference signal, taking into account the frequency-dependent behavior of sound transmission, including reflection, absorption, and diffraction. The secondary path filters may be learned in a secondary path calibration process, as described below with reference to FIG. 4. To maintain accuracy, the system may include a calibration mechanism that adjusts filter coefficients in response to environmental changes.

An adaptive step size determination module 120 is included in the signal processing unit 110. The adaptive step size determination module 120 adjusts the step size in the adaptive filtering algorithm of the noise cancellation system 100 on a per subband basis. This adjustment affects the convergence rate and stability of the adaptive filter weights within the adaptive weight filter 104. The adaptive step size determination module dynamically modifies the step size in each subband based on the power contribution of the error microphone signals and the reference signals within each respective subband, which improves convergence speed and stability of the adaptive filter weights. The adaptive step size determination module 120 calculates a normalized step size for each subband by evaluating factors such as the sum power of the filtered reference signal and the error signal, the individual power contributions of these signals, and a smoothness parameter related to their power. The module may also consider a power contribution parameter reflecting the maximum power within each subband. The resulting normalized step size is then applied to update the subband adaptive filter weights, seeking to balance between convergence speed and stability. This continuous real-time adjustment allows the noise cancellation system 100 to adapt effectively to varying noise conditions, improving the acoustic experience inside the vehicle cabin.

The gradient determination module 122 calculates the subband gradient for each subband based on the filtered subband reference signals and the corresponding subband error signals. This gradient information is essential for adjusting the adaptive filter weights to minimize the residual signal.

The subband adaptive weight update module 124 updates the adaptive filter weights in each subband based on the calculated gradients and the determined adaptive step sizes. This module 124 ensures that the noise cancelling system 100 adapts in real-time to the noise conditions within the vehicle cabin 130.

Finally, the weight transformation module 126 integrates the updated adaptive filter weights from each subband to produce the final weights for the adaptive weight filter 104 in the time domain. These updated weights are then applied to the adaptive weight filter 104 to adjust the noise cancellation signal for optimal noise reduction within the vehicle cabin 130.

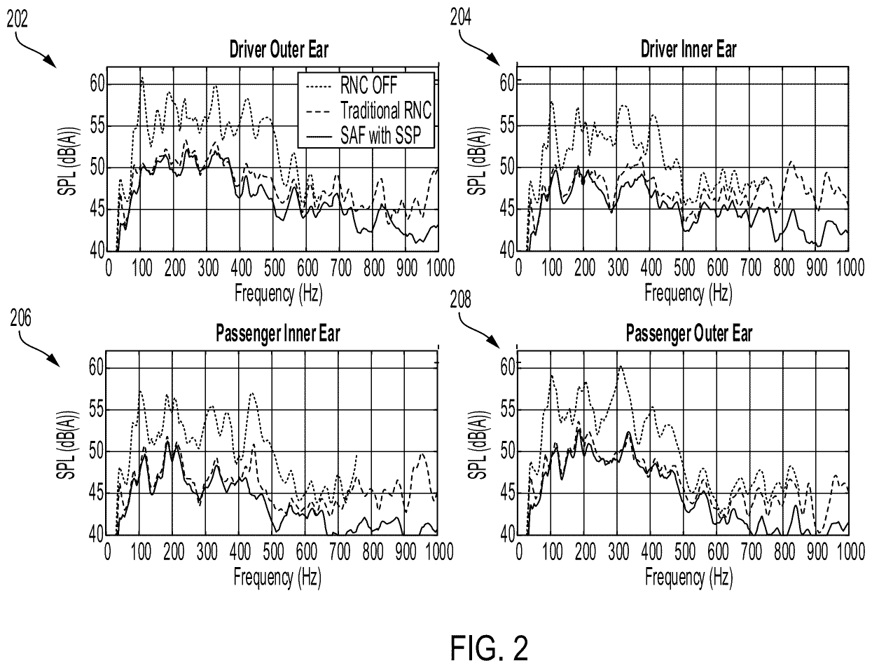

Referring to FIG. 2, simulation results comparing noise cancellation performance at different positions within a vehicle cabin are shown in graphs 202, 204, 206, and 208, representing measurements at the driver's outer car, driver's inner ear, passenger's inner car, and passenger's outer car, respectively. Each graph plots Sound Pressure Level (SPL) in dB(A) against frequency (Hz) for three conditions: RNC OFF, Traditional RNC, and SAF with SSP. The new SAF algorithm with SSP shows significant improvements in performance compared to traditional RNC algorithms across all measured positions. This improvement is particularly noticeable in the high-frequency range above 600 Hz, with the SAF with SSP algorithm consistently achieving lower SPL levels than both the RNC OFF and Traditional RNC conditions. The graphs demonstrate that the SAF with SSP approach provides enhanced noise reduction across the frequency spectrum from 0 to 1000 Hz, while maintaining lower computational cost relative to the traditional RNC algorithm. The most pronounced improvements are observed at the passenger's inner car position (graph 206), where the SAF with SSP algorithm achieves notably better attenuation of high-frequency noise components compared to both the RNC OFF and Traditional RNC conditions.

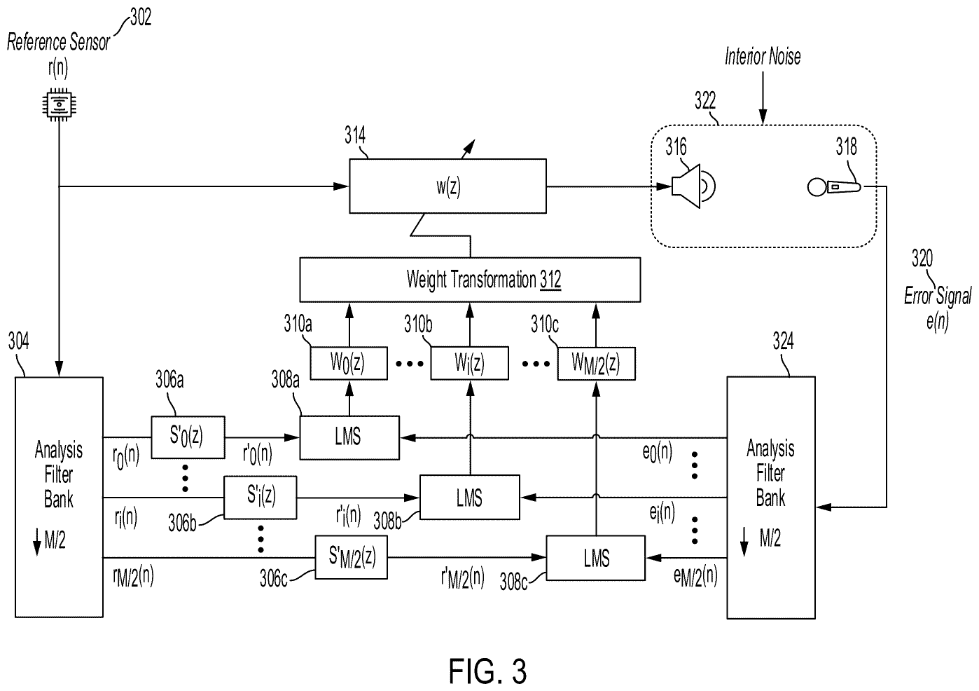

Referring to FIG. 3, a schematic of a Subband Adaptive Filter algorithm with Subband Secondary Path is shown. The algorithm includes a reference sensor 302 configured to acquire a reference signal r(n) correlated to noise within an interior noise environment 322. A first analysis filter bank 304 decomposes the reference signal into multiple subbands. Each subband analysis filter is derived from the prototype filter h₀, using a window-based lowpass filter. Depending on the intended purpose, different window functions are chosen for the prototype filter design, such as the Hamming or Kaiser windows. To generate the subband analysis filter, it is calculated by the following equation,

$${h}_{m} ( i ) = {h}_{0} {e}^{- ( \frac{j 2 π n}{N} ) i}$$

where hₘ is the impulse response of the m^{th} subband filter, M is the number of subbands, and i is i^{th} coefficient of hₘ, i=0, 1, . . . , l_{sW}, and l_{sW} is the length of the subband analysis filter. To obtain the residual signal eⱼ on the j^{th} error microphone 318, it is expressed as:

$${e}_{j} ( n ) = {d}_{j} ( n ) - {\sum }_{k = 1}^{spk} {\sum }_{l = 0}^{{l}_{w} - 1} {S}_{jk} ( l ) * {y}_{k} ( n - l )$$

$${y}_{k} ( n ) = {\sum }_{k = 1}^{spk} {\sum }_{i = 1}^{acc} {\sum }_{l = 0}^{{l}_{w} - 1} {w}_{ki} ( n ) * {r}_{i} ( n - l )$$

where eⱼ(n) is the residual signal 320 on the j^{th} error microphone 318, dⱼ(n) is the primary signal on the j^{th} error microphone, Sⱼₖ is the real impulse response of secondary path from k^{th} speaker 316 to j^{th} error microphone 318, rᵢ(n) is the i^{th} reference signal, wₖᵢ(n) is the full-length adaptive filter, l_{w} is the length of the full adaptive filter, and * is the linear convolution operator. To calculate the subband reference signal and the subband error signal, the signal subband and decomposition process is conducted using analysis filter banks 304 and 324, respectively. The subband reference signal is calculated as

$${r}_{i , m} ( κ ) = {\sum }_{l = 0}^{{l}_{sW} - 1} {h}_{m} ( l ) {r}_{i} ( κ D - l )$$

$$κ = ( n - 1 ) / D$$

where r_{i,m}(κ) is the m^{th} subband reference signal on the i^{th} reference channel, hₘ is the impulse response of the m^{th} subband analysis filter, κ is the subband index, n is the iteration, D is the decimation factor, l_{sW} is the length of the subband adaptive filter. The subband error signals are calculated by the signal subband and decomposition process based on the subband analysis filter bank 324,

$${e}_{j , m} ( κ ) = {\sum }_{l = 0}^{{l}_{sW} - 1} {h}_{m} ( i ) {e}_{j} ( κ D - l )$$

$$κ = ( n - 1 ) / D$$

where e_{j,m}(κ) is the subband error signal on the j^{th} error microphone 318 channel, D is the decimation factor, and L_{sW} is the length of the subband adaptive filter. In order to reduce the computational cost, the subband secondary path transfer functions 306a, 306b through to 306c are applied to calculate the subband filtered reference signal on each subband according to:

$${{r}^{′}}_{jki , m} ( κ ) = {\sum }_{l = 0}^{{l}_{sW} - 1} {{s}^{′}}_{jk , m} ( l ) {r}_{i , m} ( κ - l )$$

where r′_{jki,m}(κ) is the m^{th} subband filtered reference signal of i^{th} reference channel, j^{th} microphone channel, and k^{th} speaker channel, s′_{jk,m} is the subband estimated impulse response of secondary path from j^{th} error microphone 318 to k^{th} speaker 316 of the m^{th} subband filter, κ is the subband index, and l_{sW} is the length of the subband adaptive filter. Further, based on the subband filtered reference signal r′_{jki,m} and subband error signal e_{j,m}, the subband gradient G_{ki,m} is determined by LMS update blocks 308a, 308b, through to 308c, as:

$${G}_{ki , m} ( κ ) = {\sum }_{j = 1}^{mic} {{r}^{* ′}}_{jki , m} ( κ ) {e}_{j , m} ( κ )$$

Where G_{ki,m}(κ) is the m^{th} subband gradient of the i^{th} reference channel k^{th} speaker channel, r*′_{jki,m}(κ) is the complex conjugate of the m^{th} subband filtered reference signal of the i^{th} reference channel, j^{th} error microphone channel, and k^{th} speaker channel.

To determine an adjustment to the subband convergence speed and improve performance, a subband flexible adaption step size normalization method is implemented in LMS update blocks 308a, 308b, 308c based on the power contribution of the error microphone signal and reference signal. The subband flexible adaption normalized step size U_{ki,m} is calculated by the following equations:

$${P}_{ki , m} ( κ ) = {γ}_{m} {P}_{ki , m} ( κ - 1 ) + ( 1 - {γ}_{m} ) [ {\sum }_{j = 1}^{mic} {{r}^{′}}_{jki , m} ( κ ) {{r}^{* ′}}_{jki , m} ( κ ) + {α}_{m} * {\sum }_{j = 1}^{mic} {e}_{j , m} ( κ ) {{e}^{* ′}}_{j , m} ( κ ) ]$$

$${U}_{ki , m} ( κ ) = \frac{μ}{{P}_{ki , m} ( κ ) + {ϵ}_{m} * Max ( {P}_{ki , m} ( κ ) )}$$

where P_{ki,m}(κ) is the sum power for filtered reference signal and error signal of the m^{th} subband, U_{ki,m}(κ) is the i^{th} reference channel, k^{th} speaker channel, and normalized step size in the m^{th} subband filter, x′_{jki,m}(κ) is the m^{th} subband filtered reference signal of the i^{th} reference channel, j^{th} microphone channel and k^{th} speaker channel, αₘ is the m^{th} subband sum power contribution of error signal, γₘ is the m^{th} subband smooth parameter of power of filter reference signal and error signal, ϵₘ is the m^{th} subband power contribution parameter of max power of filter reference signal and error signal of each subband.

The subband adaptive filters 310a, 310b through to 310c update their weights w_{ki,m} based on the subband gradient G_{ki,m} and normalized step size U_{ki,m}, according to:

$${w}_{ki , m} ( κ + 1 ) = {γ}_{m} {w}_{ki , m} ( κ ) + {U}_{ki , m} ( κ ) {G}_{ki , m} ( κ )$$

where w_{ki,m}(κ) is the m^{th} subband adaptive filter of the i^{th} reference channel and k^{th} speaker channel, U_{ki,m}(κ) is the i^{th} reference channel, k^{th} speaker channel normalized step size of the m^{th} subband, and γₘ is the leakage of the m^{th} subband.

To obtain the full length adaptive filter in the time-domain, weight transformation block 312 transfers all subband adaptive filters w_{ki,m} to full-length adaptive filters wₖᵢ for adaptive weight filter 314 according to:

$${S}_{ki , m} = FFT ( {w}_{ki , m} , 2 \times {L}_{w} )$$

$${F}_{ki} ( f ) = {S}_{ki , \frac{fM}{4 {l}_{sW}}} ( {f}_{\frac{8 {l}_{sW}}{M}} ) \qquad f ∈ [ 0 , 2 {l}_{sW} )$$

$${F}_{ki} ( f ) = 0 \qquad f = 2 {l}_{sW}$$

$${F}_{ki} ( f ) = {{F}_{ki} ( 2 {l}_{sW} - f )}^{*} \qquad f ∈ ( 2 {l}_{sW} , 4 {l}_{sW} ]$$

$${w}_{ki} = IFFT ( {F}_{ki} )$$

$${w}_{ki} = {w}_{ki} ( 1 : {l}_{W} )$$

Where S_{ki,m} is the m^{th} subband adaptive filter in the i^{th} reference channel and k^{th} speaker channel in the frequency-domain, Fₖᵢ(f) is the subband frequency stacking of the f^{th} frequency bin, the i^{th} reference channel, and k^{th} speaker out channel, l_{sW} is the length of the subband filter, M is the number of subband filters, ( )* is the complex conjugate, wₖᵢ is the time-domain FIR filter implemented by adaptive weight filter 314 to generate the noise cancellation signal output through speaker 316 into the interior noise environment 322.

Referring to FIG. 4, to calculate the subband secondary path in either the online or offline process, a new method is proposed. This method is utilized in the Single Input Multiple output (SIMO) system, which estimates the transfer function from one speaker to multiple error microphones. A white noise generator 402 generates a reference signal r(n) that is input to both a target secondary path S (z) 404 and an estimated secondary path S′(z) 406. The outputs of these paths are combined at summation point 408 to produce a residual signal e(n). The reference signal r(n) is also processed through an analysis filter bank 410 that decomposes it into a plurality of subbands r₀(n) through r_{M/2}(n). Similarly, the residual signal e(n) is processed through another analysis filter bank 412 to produce subband error signals e₀(n) through e_{M/2}(n). Each corresponding pair of subband reference and error signals is processed by respective LMS blocks 414a, 414b, and 414c. The outputs of the LMS blocks are processed through estimated secondary path blocks S′₀(z) through S′_{M/2}(z) (416a, 416b, and 416c) and combined in a weight transformation block 418 to produce the overall estimated secondary path.

To obtain the residual signal e(n), it is expressed as:

$${e}_{j} ( n ) = {\sum }_{l = 0}^{{l}_{w} - 1} {S}_{j} ( n ) * r ( n - l ) - {\sum }_{l = 0}^{{l}_{w} - 1} {{S}^{′}}_{j} ( l ) * r ( n - l )$$

where eⱼ(n) is the residual signal of the j^{th} error microphone, Sⱼ is the measured impulse response of the secondary path from selected speaker to j^{th} error microphone, S′ⱼ is the estimated impulse response by the SAF algorithm from selected speaker to j^{th} error microphone, r (n) is the reference signal (white noise), l_{w} is the length of the full adaptive filter, and * is the linear convolution operator.

To calculate the subband reference signal rₘ and subband error signal e_{j,m}, signal subband and decomposition process is conducted. This process allows for the calculation of the subband reference signal, which is as follows:

$${r}_{m} ( κ ) = {\sum }_{l = 0}^{{l}_{sW} - 1} {h}_{m} ( l ) r ( κ D - l )$$

$${e}_{j , m} ( κ ) = {\sum }_{l = 0}^{{l}_{sW} - 1} {h}_{m} ( i ) {e}_{j} ( κ D - l )$$

$$κ = ( n - 1 ) / D$$

where rₘ(κ) is the m^{th} subband filtered signal, e_{j,m}(κ) is the m^{th} subband error signal of the j^{th} error microphone channel, hₘ is the impulse response of the m^{th} subband analysis filter, κ is the subband index, n is the iteration, D is the decimation factor, L_{sW} is the length of the subband adaptive filter.

Further, based on the subband reference signal rₘ and subband error signal e_{j,m}, the subband gradient G_{j,m} can be calculated as,

G_{j,m}(κ)=r*ₘ(κ)e_{j,m}(κ)
where G_{j,m}(κ) is the m^{th} subband gradient of the j^{th} error microphone channel, r′ₘ(κ) is the complex conjugate of the m^{th} subband reference signal.

To adjust the subband secondary path convergence speed, simple subband step size normalization method is applied, which is based on the power contribution of reference signal to adjust the step size. The normalized step size Uₘ can be calculated in the following equations:

$${U}_{m} ( κ ) = \frac{μ}{{r}_{m} ( κ ) {{r}^{*}}_{m} ( κ ) + α}$$

where Uₘ(κ) is the normalized step size of the m^{th} subband, rₘ(κ) is the m^{th} subband reference signal, and α is the constant value.

Hence, subband secondary path s′_{j,m} is calculated and updated in the following equation, which is based on the subband gradient G_{j,m} and the normalized step size Uₘ

$${{s}^{′}}_{j , m} ( κ + 1 ) = {γ}_{m} {{s}^{′}}_{j , m} ( κ ) + {U}_{m} ( κ ) {G}_{j , m} ( κ )$$

where s′_{j,m}(κ) is the m^{th} estimated subband secondary path of the j^{th} error microphone channel, Uₘ(κ) is the normalized step size of the m^{th} subband, and γₘ is the leakage of the m^{th} subband.

To obtain the time-domain estimated secondary path and verify the subband secondary path, a subband weight transformation process is employed, which transfers subband secondary paths s′_{j,m} to the full-length estimated secondary paths s′ⱼ.

$${S}_{j , m}^{′} = FFT ( {s}_{j , m}^{′} , 2 \times {L}_{s W} )$$

$${F}_{j} ( f ) = {s}_{j , \frac{f M}{4 {l}_{s W}}}^{′} ( {f}_{\frac{8 {l}_{s W}}{M}} ) f ∈ [ 0 , 2 {l}_{s W} )$$

$${F}_{j} ( f ) = 0 f = 2 {l}_{s W}$$

$${F}_{j} ( f ) = {{F}_{j} ( 2 {l}_{s W} - f )}^{*} f ∈ ( 2 {l}_{sW} , 4 {l}_{s W} ]$$

$${s}_{j}^{′} = IFFT ( {F}_{j} )$$

$${s}_{j}^{′} = {s}_{j}^{′} ( 1 : {l}_{W} )$$

where S′_{j,m} is the m^{th} frequency-domain subband secondary path of the j^{th} error microphone, Fⱼ(f) is the f^{th} frequency bin of the j^{th} error microphone channel, l_{sW} is the length of the subband secondary path, M is the number of subbands, ( )* is the complex conjugate, and s′ⱼ is the full length estimated secondary path.

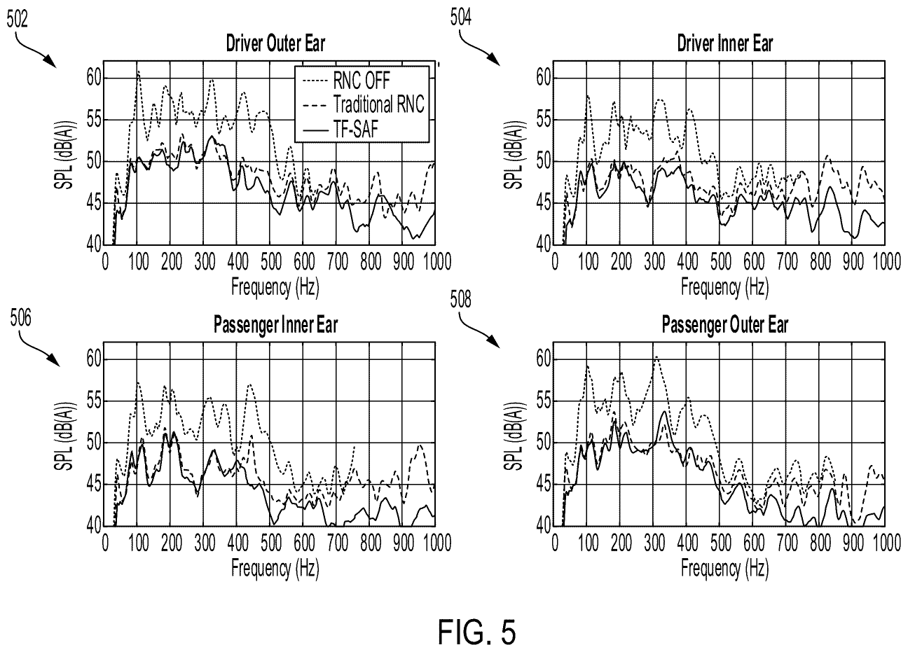

Referring to FIG. 5, simulation results comparing noise cancellation performance at different positions within a vehicle cabin are shown in graphs 502, 504, 506, and 508, representing measurements at the driver's outer ear, driver's inner ear, passenger's inner ear, and passenger's outer ear, respectively. Each graph plots Sound Pressure Level (SPL) in dB(A) against frequency (Hz) for three conditions: RNC OFF (dotted line), Traditional RNC (dashed line), and TF-SAF (solid line). The time-frequency subband adaptive filter (TF-SAF) algorithm shows significant improvements across the broadband frequency range compared to both the RNC OFF and Traditional RNC conditions. The graphs demonstrate SPL measurements ranging from approximately 40 to 60 dB(A) across frequencies from 0 to 1000 Hz, with higher SPL levels (50-60 dB) observed at lower frequencies and lower levels (40-50 dB) at higher frequencies. The TF-SAF algorithm consistently achieves better noise reduction across all measured positions while maintaining lower computational cost relative to the traditional time-domain SAF algorithm.

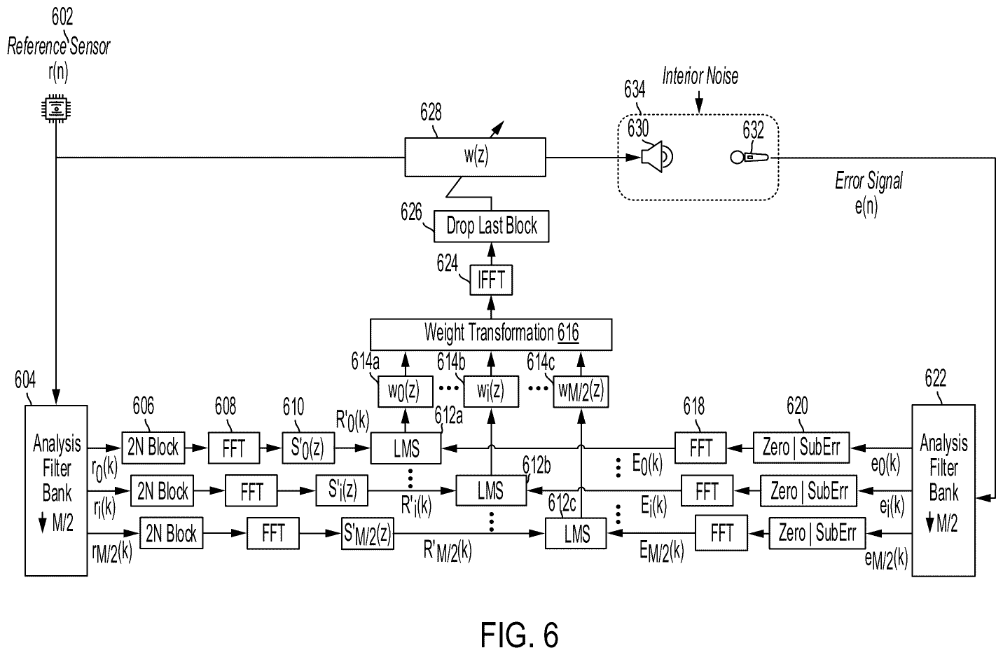

Referring to FIG. 6, a schematic of the proposed time-frequency subband adaptive filter (TF-SAF) algorithm is shown. The algorithm includes a reference sensor 602 configured to acquire a reference signal r(n) correlated to noise within an interior noise environment 634. An analysis filter bank 604 decomposes the reference signal into multiple subbands using a set of subband analysis filters. Each subband analysis filter is derived from a prototype filter h₀, using a window-based lowpass filter. Depending on the intended purpose, different window functions are chosen for the prototype filter design, such as the Hamming or Kaiser windows. To generate the subband analysis filter, it is calculated by the following equation:

$${h}_{m} ( i ) = {h}_{0} {e}^{- ( \frac{j 2 π n}{N} ) i}$$

where hₘ is the impulse response of the m^{th} subband filter, M is the number of subbands, and i is i^{th} coefficient of hₘ, i=0, 1, . . . , l_{sW}, and l_{sW} is the length of the subband analysis filter.

The residual signal e(n) is obtained through the error microphone 632 and is expressed as:

$${e}_{j} ( n ) = {d}_{j} ( n ) - {\sum }_{k = 1}^{s p k} {\sum }_{l = 0}^{{l}_{w} - 1} {S}_{j k} ( l ) * {y}_{k} ( n - l )$$

$${y}_{k} ( n ) = {\sum }_{k = 1}^{s p k} {\sum }_{i = 1}^{a c c} {\sum }_{l = 0}^{{l}_{w} - 1} {w}_{k i} ( n ) * {r}_{i} ( n - l )$$

where eⱼ(n) is the residual signal on the j^{th} error microphone 632, dⱼ(n) is the primary signal on the j^{th} error microphone 632, Sⱼₖ is the real impulse response of secondary path from k^{th} speaker 630 to j^{th} error microphone 632, rᵢ(n) is the i^{th} reference signal, wₖᵢ(n) is the full-length adaptive filter, l_{w} is the length of the full adaptive filter, and * is the linear convolution operator.

The analysis filter bank 604 processes the subband reference signal through signal subband and decomposition. The subband reference signal is calculated as:

$${r}_{i , m} ( κ ) = {\sum }_{l = 0}^{{l}_{s W} - 1} {h}_{m} ( l ) {r}_{i} ( κ D - l )$$

$$κ = ( n - 1 ) / D$$

where r_{i,m}(κ) is the m^{th} subband reference signal on the i^{th} reference channel, hₘ is the impulse response of the m^{th} subband analysis filter, κ is the subband index, n is the iteration, D is the decimation factor, l_{sW} is the length of the subband adaptive filter.

The subband error signals are calculated by the signal subband and decomposition process based on the analysis filter bank 622:

$${e}_{j , m} ( κ ) = {\sum }_{l = 0}^{{l}_{s W} - 1} {h}_{m} ( i ) {e}_{j} ( κ D - l )$$

$$κ = ( n - 1 ) / D$$

where e_{j,m}(κ) is the subband error signal on the j^{th} error microphone channel 632, D is the decimation factor, and L_{sW} is the length of the subband adaptive filter.

The 2N block 606 processes the subband signals by forming a 2N block vector of the reference signal, where N is a block size equal to the length of the subband adaptive filter (L_{sW}). The Zero SubErr blocks 620 process the error signals by appending N zero blocks to the error signal to form a 2N block vector. These processing steps prepare the subband reference and error signals for frequency domain processing and implement the overlap-save method to avoid wrap-around effects during the FFT operations. The 2N block vectors created by blocks 606 and 620 enable proper linear convolution in the frequency domain while preventing circular correlation artifacts that could otherwise degrade the noise cancellation performance.

To update frequency-domain subband adaptive filters in linear convolution, the subband overlap-save method is applied to the TF-SAF algorithm through FFT blocks 608 and 618. Hence, a signal block process is required for subband reference signals and subband error signals. The subband filtered reference signal block rᵢ and subband error signal block vector eⱼ are expressed as:

$${r}_{i , m} ( κ ) = [ {r}_{i , m} ( κ N - N ) … {r}_{i , m} ( κ N - 1 ) {r}_{i , m} ( κ N ) … {r}_{i , m} ( κ N + N - 1 ) ]$$

$${e}_{j , m} ( κ ) = [ 0 … 0 {e}_{j , m} ( κ N ) {e}_{j , m} ( κ N + N - 1 ) ]$$

where r_{i,m}(κ) is the block vector of the m^{th} subband reference signal on the i^{th} reference channel, e_{j,m}(κ) is the block vector of the subband error signal on the j^{th} error microphone channel 632, κ is the block index, N is the block size that is equal to the length of the subband adaptive filter (l_{sW}).

Then, reference signal block vector rᵢ and error signal block vector eⱼ are transformed into frequency-domain using FFT blocks 608 and 618, which is computed as follows:

R_{i,m}(f)=FFT[r_{i,m}(κ)]

E_{j,m}(f)=FFT[e_{j,m}(κ)]
where R_{i,m}(κ) is the frequency-domain m^{th} subband filtered reference signal on the i^{th} reference channel, E_{j,m}(κ) is the frequency-domain m^{th} subband error signal on j^{th} error microphone channel 632.

To further reduce the computational load, the frequency-domain secondary path S′_{jk,m} is applied through blocks 610. It is used to calculate the subband filtered reference signal for each subband as follows:

R′_{ijk,m}(f)=S′_{jk,m}R_{i,m}(f)
where R′_{ijk,m}(f) is the frequency-domain m^{th} subband filtered reference signal on i^{th} reference channel, j^{th} microphone channel, and k^{th} speaker channel, S′_{jk,m} is the frequency-domain m^{th} subband estimated impulse response of the subband secondary path from j^{th} error microphone 632 to k^{th} speaker 630.

Further, based on the frequency-domain subband filtered reference signal R′_{ijk,m} and frequency-domain subband error signal E_{j,m}, the frequency-domain subband gradient G_{ki,m} can through LMS blocks 612a, 612b, 612c as:

G_{ki,m}(f)=R*′_{jki,m}(f)E_{j,m}(f)

Where G_{ki,m}(f) is the m^{th} subband gradient on the i^{th} reference channel and k^{th} speaker channel, R*′_{jki,m}(f) is the complex conjugate of the frequency-domain m^{th} subband filtered reference signal on the i^{th} reference channel, j^{th} error microphone channel, and k^{th} speaker channel.

To enhance the convergence speed and performance of the proposed TF-SAF algorithm, a frequency-domain subband flexible adaptive step size normalization method is implemented in blocks 614a, 614b, 614c, which is based on the power contribution of error microphone signal and reference signal to adjust the step size. Subband adaptive normalized step size U_{ki,m} in the frequency-domain is calculated by the following equation:

$${P}_{ki , m} ( κ ) = {γ}_{m} {P}_{ki , m} ( κ - 1 ) + ( 1 - {γ}_{m} ) [ {{\sum }^{mic}}_{j = 1} {\sum }_{f = 1}^{f = {l}_{sW}} {R}_{jki , m}^{′} ( f ) {R}_{jki , m}^{* ′} ( f ) + {α}_{m} * {{\sum }^{mic}}_{j = 1} {\sum }_{f = 1}^{f = {l}_{sW}} {E}_{j , m} ( f ) {E}_{j , m}^{* ′} ( f ) ]$$

$${U}_{ki , m} ( κ ) = \frac{μ}{{P}_{k i , m} ( κ ) + {ϵ}_{m} * Max ( {P}_{k i , m} ( κ ) )}$$

where P_{ki,m}(κ) is the sum power for filtered reference signal and error signal on the m^{th} subband, U_{ki,m}(κ) is the i^{th} reference channel and k^{th} speaker channel normalized step size in the m^{th} subband filter, R′_{jki,m}(κ) is the m^{th} subband filtered reference signal on the i^{th} reference channel, j^{th} microphone channel, and k^{th} speaker channel, αₘ is the m^{th} subband sum power contribution of the error signal, γₘ is the m^{th} subband smooth parameter of the power of filtered reference signal and error signal, ϵₘ is the m^{th} subband power contribution parameter of max power of filtered reference signal and error signal on each subband.

Next, the frequency-domain subband adaptive filter weight W_{ki,m} is calculated and updated through weight transformation block 616 as per the following equation, which is based on frequency-domain subband gradient G_{ki,m} and the frequency-domain normalized step size U_{ki,m}

$${W}_{ki , m} ( κ + 1 ) = {γ}_{m} {W}_{ki , m} ( κ ) + {U}_{ki , m} ( κ ) {G}_{ki , m} ( κ )$$

where W_{ki,m}(κ) is the frequency-domain m^{th} subband adaptive filter on the i^{th} reference channel and k^{th} speaker channel, U_{ki,m}(κ) is the frequency-domain m^{th} subband normalized step size on i^{th} reference channel and k^{th} speaker channel, and γₘ is the leakage on the m^{th} subband on the frequency-domain.

To obtain the full-length time-domain adaptive filter wₖᵢ, a subband weight transformation process is utilized in the TF-SAF algorithm through IFFT block 624 and drop last block 626, which transfers frequency-domain subband adaptive filters W_{ki,m} to time-domain full-length adaptive filters wₖᵢ, implemented by adaptive weight filter 628:

$${F}_{k i} ( f ) = {W}_{ki , \frac{f M}{4 {l}_{s W}}} ( {f}_{\frac{8 {l}_{s W}}{M}} ) f ∈ [ 0 , 2 {l}_{s W} )$$

$${F}_{k i} ( f ) = 0 f = 2 {l}_{s W}$$

$${F}_{k i} ( f ) = {{F}_{k i} ( 2 {l}_{s W} - f )}^{*} f ∈ ( 2 {l}_{sW} , 4 {l}_{s W} ]$$

$${w}_{k i} = IFFT ( {F}_{k i} )$$

$${w}_{k i} = {w}_{k i} ( 1 : {l}_{W} )$$

where Fₖᵢ(f) is the f^{th} frequency bin on the i^{th} reference channel and k^{th} speaker output channel, l_{sW} is the length of the subband filter, M is the number of subband filters, ( )* is the complex conjugate, wₖᵢ is the time-domain FIR filter on the i^{th} reference channel and k^{th} speaker channel implemented by adaptive weight filter 628 to generate the noise cancellation signal output through speaker 630 into the interior noise environment 634.

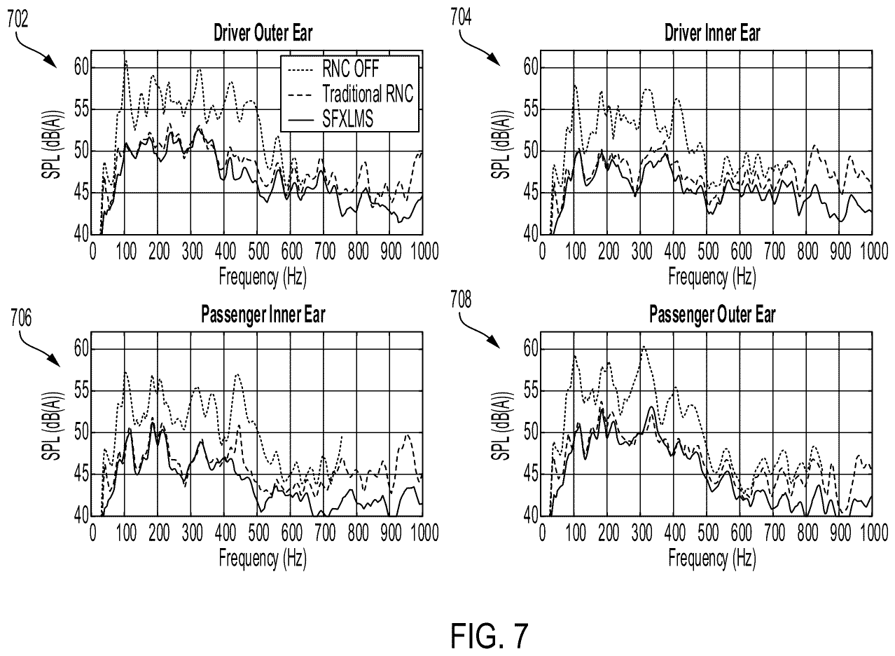

Referring to FIG. 7, simulation results comparing noise cancellation performance at different positions within a vehicle cabin are shown in graphs 702, 704, 706, and 708, representing measurements at the driver's outer ear, driver's inner ear, passenger's inner ear, and passenger's outer ear, respectively. Each graph plots Sound Pressure Level (SPL) in dB(A) against frequency (Hz) for three conditions: RNC OFF (dotted line), Traditional RNC (dashed line), and SFXLMS (solid line). The subband filtered-x least mean square (SFXLMS) algorithm shows significant improvements across the broadband frequency range compared to both the RNC OFF and Traditional RNC conditions. The graphs demonstrate SPL measurements ranging from approximately 40 to 60 dB(A) across frequencies from 0 to 1000 Hz, with higher SPL levels (50-60 dB) observed at lower frequencies and lower levels (40-50 dB) at higher frequencies. This improvement is especially noticeable in the high-frequency range with an overall increase of 2.4 dB in noise reduction performance. The SFXLMS algorithm consistently achieves better noise reduction across all measured positions while maintaining lower computational cost relative to the traditional time-domain SAF algorithm.

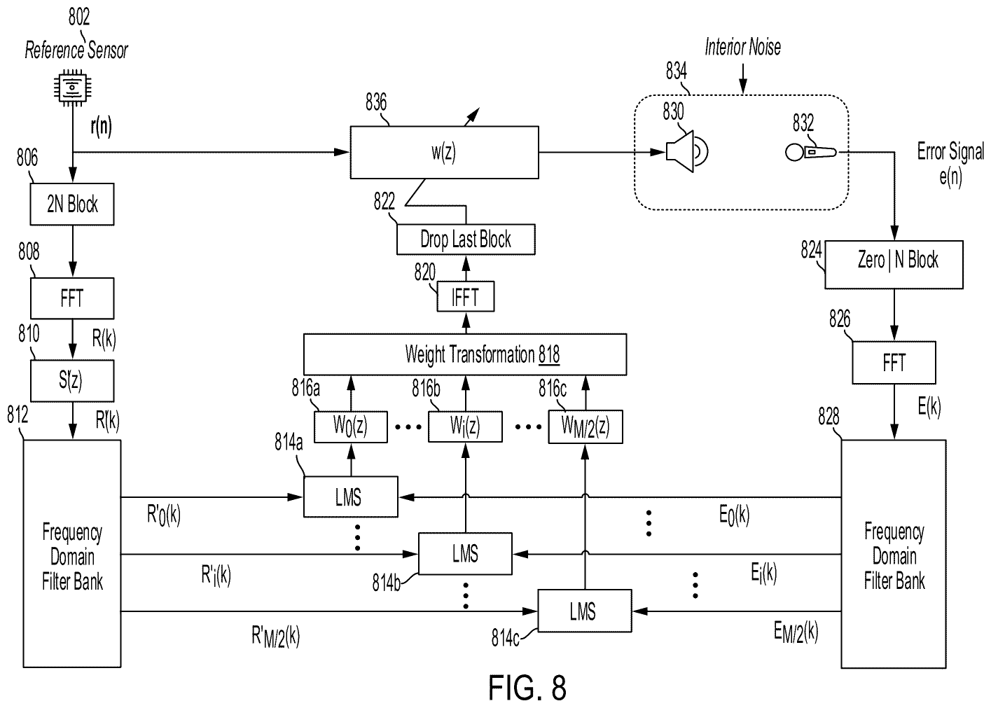

Referring to FIG. 8, a schematic of the proposed subband filtered-x least mean square (SFXLMS) algorithm is shown. The algorithm includes a reference sensor 802 configured to acquire a reference signal r(n) correlated to noise within an interior noise environment 834. Compared to the conventional subband adaptive filter (SAF) algorithm, one advantage lies in eliminating the need for subband filtering, and processing subband adaptive filter updates on a block-by-block basis. This allows for reduction of algorithmic complexity and computational cost. Additionally, the proposed algorithm can also be employed for virtual microphone technology.

The residual signal e(n) from error microphone 832 is expressed as:

$${e}_{j} ( n ) = {d}_{j} ( n ) - {\sum }_{k = 1}^{s p k} {\sum }_{l = 0}^{{l}_{w} - 1} {S}_{j k} ( l ) * {y}_{k} ( n - l )$$

$${y}_{k} ( n ) = {\sum }_{k = 1}^{s p k} {\sum }_{i = 1}^{a c c} {\sum }_{l = 0}^{{l}_{w} - 1} {w}_{k i} ( n ) * {r}_{i} ( n - l )$$

where eⱼ(n) is the residual signal on the j^{th} error microphone 832, dⱼ(n) is the primary signal on the j^{th} error microphone 832, Sⱼₖ is the real acoustic impulse response of secondary path from the k^{th} speaker 830 to the j^{th} error microphone 832, rᵢ(n) is the i^{th} reference signal, wₖᵢ(n) is the full length adaptive filter, l_{w} is the length of the adaptive filter, and * is the linear convolution operator.

The 2N block 806 processes the reference signal by forming a 2N block vector, where N is a block size equal to the length of the adaptive filter (l_{w}). The Zero N block 824 processes the error signal by appending N zero blocks to form a 2N block vector. These blocks prepare the signals for frequency domain processing using FFT blocks 808 and 826 respectively.

Compared to the traditional SAF algorithm, the SFXLMS method does not require the subband filtering process in the time-domain, and instead uses the FFT method. To avoid the wrap-around effect of the circular correlation of the FFT process, an overlap-save method is applied. Hence, reference signal block rᵢ and error signal block eⱼ are expressed as:

$${r}_{i} ( κ ) = [ {r}_{i} ( κ N - N ) … {r}_{i , m} ( κ N - 1 ) {r}_{i , m} ( κ N ) … {r}_{i , m} ( κ N + N - 1 ) ]$$

$${e}_{j} ( κ ) = [ 0 … 0 {e}_{j} ( κ N ) {e}_{j} ( κ N + N - 1 ) ]$$

where rᵢ(κ) is the 2N block vector of reference signal on the i^{th} reference channel, eⱼ(κ) is the 2N block vector of the error signal on the j^{th} error microphone channel adding N zero blocks on the first N points, κ is the block index, N is the block size that is equal to the full length of the adaptive filter (l_{w}). Generation of the 2N block vectors for the reference signal and error signal may be performed at operation 806 and 824, respectively.

Then, reference signal block vector rᵢ and error signal block vector eⱼ are transformed into the frequency-domain using FFT, at operations 808 and 826 respectively, as follows:

Rᵢ(f)=FFT[rᵢ(κ)]

Eⱼ(f)=FFT[eⱼ(κ)]
where Rᵢ(f) is the frequency-domain reference signal of the i^{th} reference channel, and Eⱼ(f) is the frequency-domain error signal of the j^{th} error microphone channel.

To further reduce the computational load, the frequency-domain secondary path S′ⱼₖ is applied at operation 810. It is used to calculate the frequency-domain secondary path filtered reference signal as follows:

R′ᵢⱼₖ(f)=S′ⱼₖ(f)Rᵢ(f)
where R′ᵢⱼₖ(f) is the frequency-domain filtered reference signal of the i^{th} reference channel, j^{th} microphone channel 832, and k^{th} speaker channel 830. S′ⱼₖ(f) is the frequency-domain estimated impulse response of secondary path from the j^{th} error microphone 832 to the k^{th} speaker 830.

To reduce the complexity of the proposed algorithm, a new frequency-domain subband process through frequency domain filter banks 812 and 828, which directly processes the signal from full band frequency domain to subband frequency domain, is applied. As a result, the frequency-domain subband reference signals are calculated as follows:

$${R}_{ijk}^{′} = [ {0}_{4 lw / M} , {R}_{ijk}^{′} , {0}_{4 lw / M} ]$$

$${R}_{ijk , m}^{′} ( f ) = {R}_{ijk}^{′} ( {f}_{\frac{2 m {l}_{w}}{M} + 1 : \frac{2 ( m + 1 ) {l}_{w}}{M}} )$$

$${E}_{j}^{′} = [ {0}_{4 lw / M} , {E}_{j}^{′} , {0}_{4 lw / M} ]$$

$${E}_{j , m}^{′} ( f ) = {E}_{j}^{′} ( {f}_{\frac{2 m {l}_{w}}{M} + 1 : \frac{2 ( m + 1 ) {l}_{w}}{M}} )$$

$${l}_{s W} = \frac{2 {l}_{w}}{M}$$

where R′_{ijk,m}(f) is the frequency-domain m^{th} subband reference signal of the i^{th} reference channel, j^{th} microphone channel, and k^{th} speaker channel. E_{j,m}(f) is the frequency-domain m^{th} subband error signal of the j^{th} error microphone channel, 0_{4lw/M} is the zero block vector that includes 4l_{w}/M zeros, l_{w} is the length of the adaptive filter, L_{sW} is the length of the subband adaptive filter, M is the number of subbands.

Further, based on the frequency-domain subband filtered reference signal R′_{ijk,m} and frequency-domain subband error signal E_{j,m}, the frequency-domain subband gradient G_{ki,m} is calculated through LMS blocks 814a, 814b, and 814c as:

G_{ki,m}(f)=R*′_{jki,m}(f)E_{j,m}(f)
where G_{ki,m}(f) is the frequency-domain m^{th} subband gradient on the i^{th} reference channel and k^{th} speaker channel, R*′_{jki,m}(κ) is the complex conjugate of the frequency-domain m^{th} subband filtered reference signal on the i^{th} reference channel, j^{th} error microphone channel, and k^{th} speaker channel.

To improve the convergence speed and improve the proposed SFXLMS algorithm performance, frequency-domain subband flexible adaptive step size normalization is implemented through subband adaptive filters 816a, 816b, 816c, which is based on the power contribution of the error microphone and reference signals to adjust the step size. Subband flexible adaptive normalized step size U_{ki,m} in the frequency-domain is calculated by the following equation,

$${P}_{ki , m} ( κ ) = {γ}_{m} {P}_{ki , m} ( κ - 1 ) + ( 1 - {γ}_{m} ) [ {{\sum }^{mic}}_{j = 1} {\sum }_{f = 1}^{f = {l}_{sW}} {R}_{jki , m}^{′} ( f ) {R}_{jki , m}^{* ′} ( f ) + {α}_{m} * {{\sum }^{mic}}_{j = 1} {\sum }_{f = 1}^{f = {l}_{sW}} {E}_{j , m} ( f ) {E}_{j , m}^{* ′} ( f ) ]$$

$${U}_{ki , m} ( κ ) = \frac{μ}{{P}_{k i , m} ( κ ) + {ϵ}_{m} * Max ( {P}_{k i , m} ( κ ) )}$$

where P_{ki,m}(κ) is the sum power for filtered reference and error signals of the m^{th} subband, U_{ki,m}(κ) is the i^{th} reference channel and k^{th} speaker channel normalized step size in the m^{th} subband filter, R′_{jki,m}(f) is the frequency-domain m^{th} subband filtered reference signal of the i^{th} reference channel, j^{th} microphone channel, and k^{th} speaker channel, αₘ is the sum power contribution of the error signal, γₘ is the smoothing parameter of power of filter reference and error signals, ϵₘ is the power contribution parameter of max power of filter reference and error signals on each subband.

Next, the frequency-domain subband adaptive filter weight W_{ki,m} is calculated and updated through weight transformation block 818 as per the following equation, which is based on frequency-domain subband gradient G_{ki,m} and frequency-domain normalized step size U_{ki,m}

$${W}_{ki , m} ( κ + 1 ) = {γ}_{m} {W}_{ki , m} ( κ ) + {U}_{ki , m} ( κ ) {G}_{ki , m} ( κ )$$

where W_{ki,m}(κ) is the frequency-domain m^{th} subband adaptive filter of the i^{th} reference channel and k^{th} speaker channel, U_{ki,m}(κ) is the frequency-domain m^{th} subband normalized step size of the i^{th} reference channel and k^{th} speaker channel, and γₘ is the leakage of the m^{th} subband.

To obtain the full-length adaptive filter wₖᵢ in the time-domain, a subband weight transformation process is utilized in the SFXLMS algorithm through IFFT block 820 and drop last block 822, which transfers frequency-domain subband adaptive filters W_{ki,m} to time-domain full-length adaptive filters wₖᵢ, implemented by adaptive weight filter 836:

$${W}_{ki} ( {f}_{2 m {l}_{sW} + 1 : 2 ( m + 1 ) {l}_{sW}} ) = {W}_{ki , m}$$

$${W}_{ki}^{′} ( f ) = {{W}_{ki} ( {l}_{w} - f )}^{*}$$

$${w}_{ki} = IFFT ( drop the first and last of \frac{4 {l}_{w}}{M} vector in the [ {W}_{ki} , {W}_{ki}^{′} ] )$$

$${w}_{ki} = {w}_{ki} ( 1 : {l}_{w} )$$

where Wₖᵢ is the frequency-domain full band adaptive filter of the i^{th} reference channel and the k^{th} speaker output channel, W′ₖᵢ is the complex conjugate of the flipped Wₖᵢ of the frequency-domain, wₖᵢ is the time-domain FIR filter of the i^{th} reference channel and k^{th} speaker channel, l_{sW} is the length of the subband filter, l_{w} is the length of the full adaptive filter, and ( )* is the complex conjugate.

The disclosure also provides support for a method for noise cancellation in a vehicle having a reference sensor configured to acquire a reference signal correlated to noise within a vehicle cabin, a plurality of speakers positioned within the vehicle cabin configured to emit a noise cancellation signal, and a plurality of error microphones positioned within the vehicle cabin recording a residual signal, the method comprising: processing the reference signal with an adaptive weight filter to produce the noise cancellation signal, applying a set of analysis filters to decompose the residual signal into a plurality of subband error signals and to decompose the reference signal into a plurality of subband reference signals, applying a respective subband secondary path transfer function to each subband reference signal to produce a plurality of filtered subband reference signals, determining a subband gradient for each subband based on a respective filtered subband reference signal and a respective subband error signal, determining an adaptive step size for updating subband adaptive filter weights for each of a plurality of subband adaptive filters, updating a plurality of adaptive filter weights in each of the plurality of subband adaptive filters based on a respective adaptive step size and gradient, and integrating the plurality of adaptive filter weights in each of the plurality of subband adaptive filters to produce updated weights for the adaptive weight filter, wherein the updated weights are applied to the adaptive weight filter to adjust the noise cancellation signal. In a first example of the method, the set of analysis filters includes a plurality of subband filters derived from a prototype filter using a window-based lowpass filter, each subband filter corresponding to a distinct frequency range within a vehicle cabin noise spectrum, and wherein the method further comprises selecting a window function for the prototype filter based on a predetermined frequency response characteristic for each subband. In a second example of the method, optionally including the first example, determining the adaptive step size for updating subband adaptive filter weights further comprises determining the adaptive step size based on a power contribution of the subband error signal and the filtered subband reference signal. In a third example of the method, optionally including one or both of the first and second examples, applying the respective subband secondary path transfer function to each subband reference signal further comprises: generating a white noise reference signal, recording a residual signal at each of the plurality of error microphones resulting from emission of the white noise reference signal through the plurality of speakers, decomposing the white noise reference signal and the residual signal into their respective subband components using the set of analysis filters, calculating a subband gradient for each subband based on the decomposed subband components of the white noise reference signal and the residual signal, and updating the subband secondary path transfer function for each subband based on the calculated subband gradient and a normalized step size, wherein the normalized step size is determined based on a power contribution of the decomposed subband components of the white noise reference signal and the residual signal. In a fourth example of the method, optionally including one or more or each of the first through third examples, the reference sensor comprises at least one of an accelerometer configured to detect vibrations associated with the vehicle, a microphone configured to detect ambient noise outside the vehicle cabin, and a non-acoustic sensor configured to detect operational parameters of the vehicle indicative of noise generation.

The disclosure also provides support for a noise cancellation system for a vehicle, comprising: a reference sensor configured to acquire a reference signal correlated to noise within a vehicle cabin, an adaptive weight filter in electronic communication with the reference sensor, configured to apply an adaptive filtering process to the reference signal to produce a noise cancellation signal, a plurality of speakers positioned within the vehicle cabin and in electronic communication with the adaptive weight filter, configured to emit the noise cancellation signal into the vehicle cabin, a plurality of error microphones positioned within the vehicle cabin and configured to record a residual signal resulting from interaction of the emitted noise cancellation signal and the noise within the vehicle cabin, and a signal processing unit in electronic communication with the reference sensor and the plurality of error microphones, wherein the signal processing unit comprises: a non-transitory memory storing a set of subband filters, and instructions, and a processor, wherein, when executing the instructions, the processor is configured to: decompose the residual signal into a plurality of subband error signals and to decompose the reference signal into a plurality of subband reference signals, convert the plurality of subband reference signals and the plurality of subband error signals into a plurality of subband reference signal blocks and a plurality of subband error signal blocks, respectively, transform the plurality of subband error signal blocks and the plurality of subband reference signal blocks into a plurality of frequency-domain subband error signals and a plurality of frequency-domain subband reference signals, respectively, apply a frequency-domain secondary path filter to the plurality of frequency-domain subband reference signals to produce a plurality of frequency-domain subband filtered reference signals, determine a frequency-domain subband gradient for each subband based on a respective frequency-domain subband filtered reference signal and a corresponding frequency-domain subband error signal, determine an adaptive step size for updating frequency-domain subband adaptive filter weights for each of a plurality of frequency-domain subband adaptive filters, update a plurality of frequency-domain adaptive filter weights in each of the plurality of frequency-domain subband adaptive filters based on a respective frequency-domain adaptive step size and frequency-domain subband gradient, and integrate the plurality of frequency-domain adaptive filter weights in each of the plurality of frequency-domain subband adaptive filters to produce updated weights for the adaptive weight filter in a time domain, wherein the updated weights are applied to the adaptive weight filter to adjust the noise cancellation signal. In a first example of the system, the signal processing unit is further configured to implement a subband overlap-save method to update the adaptive weight filter according to linear convolution to avoid a wrap-around effect caused by circular correlation in a frequency domain. In a second example of the system, optionally including the first example, the signal processing unit is further configured to multiply the plurality of frequency-domain subband reference signals with a secondary path filter in each subband to achieve secondary path filtering without requiring time-domain convolution. In a third example of the system, optionally including one or both of the first and second examples, the signal processing unit is further configured to employ a frequency-domain subband flexible adaptation step size normalization method based on a power contribution of error microphone signals and reference signals to adjust the adaptive step size for each subband. In a fourth example of the system, optionally including one or more or each of the first through third examples, the signal processing unit is further configured to perform an inverse Fast Fourier Transform (IFFT) on the plurality of frequency-domain adaptive filter weights to obtain the updated weights for the adaptive weight filter in the time domain.

The disclosure also provides support for a method comprising: acquiring a reference signal using a reference sensor, wherein the reference signal is correlated with noise in a vehicle cabin, emitting a noise cancellation signal using a plurality of speakers positioned in the vehicle cabin, acquiring a residual signal from a plurality of error microphones positioned in the vehicle cabin, transforming the reference signal and the residual signal into a frequency-domain reference signal and a frequency-domain residual signal, respectively, using a Fast Fourier Transform (FFT), applying a secondary path filter to the frequency-domain reference signal to produce a frequency-domain filtered reference signal, decomposing the frequency-domain filtered reference signal and the frequency-domain residual signal into a plurality of subband signals, calculating a frequency-domain subband gradient for each subband based on the decomposed frequency-domain filtered reference signal and the frequency-domain residual signal, updating a set of subband adaptive filter weights in a frequency domain based on the frequency-domain subband gradient and a frequency-domain subband flexible adaptation step size normalization, transforming the updated set of subband adaptive filter weights from the frequency domain to a time domain using an Inverse Fast Fourier Transform (IFFT), and emitting the noise cancellation signal based on the transformed subband adaptive filter weights to reduce noise in the vehicle cabin. In a first example of the method, acquiring of the reference signal includes detecting vibrations from a road surface using the reference sensor. In a second example of the method, optionally including the first example, the applying of the secondary path filter includes multiplying the frequency-domain reference signal with a frequency-domain estimated impulse response of a secondary path from the speakers to the error microphones. In a third example of the method, optionally including one or both of the first and second examples, decomposing into a plurality of subband signals includes dividing a frequency spectrum into a predetermined number of frequency bands. In a fourth example of the method, optionally including one or more or each of the first through third examples, calculating of the frequency-domain subband gradient for each subband includes performing a complex conjugate multiplication of the frequency-domain filtered reference signal and the frequency-domain residual signal. In a fifth example of the method, optionally including one or more or each of the first through fourth examples, updating of the set of subband adaptive filter weights includes employing a leakage factor to prevent divergence of the adaptive filter weights. In a sixth example of the method, optionally including one or more or each of the first through fifth examples, transforming of the updated set of subband adaptive filter weights includes applying an overlap-save method to mitigate wrap-around effects during the IFFT. In a seventh example of the method, optionally including one or more or each of the first through sixth examples, the emitting of the noise cancellation signal based on the transformed subband adaptive filter weights includes adjusting a volume and phase of the noise cancellation signal for each speaker individually. In a eighth example of the method, optionally including one or more or each of the first through seventh examples, the method further comprises: adjusting the frequency-domain subband flexible adaptation step size normalization based on a power contribution of the plurality of error microphones and reference signals to optimize the step size for each subband. In a ninth example of the method, optionally including one or more or each of the first through eighth examples, transforming the reference signal and the residual signal into the frequency-domain reference signal and the frequency-domain residual signal further comprises: forming a 2N block vector of the residual signal by appending N zero blocks to the residual signal, and applying the Fast Fourier Transform (FFT) to the 2N block vector to obtain the frequency-domain residual signal, wherein N is a block size equal to a full length of an adaptive filter.

The foregoing descriptions are merely example embodiments adopted to illustrate the principles of the present application, and are not used to limit the protection scope of the present application. For those of ordinary skill in the art, various modifications and improvements can be made without departing from the spirit and essence of the present application, and these modifications and improvements are also within the protection scope of the present application.

1. A method for noise cancellation in a vehicle having a reference sensor configured to acquire a reference signal correlated to noise within a vehicle cabin, a plurality of speakers positioned within the vehicle cabin configured to emit a noise cancellation signal, and a plurality of error microphones positioned within the vehicle cabin recording a residual signal, the method comprising:
processing the reference signal with an adaptive weight filter to produce the noise cancellation signal;
applying a set of analysis filters to decompose the residual signal into a plurality of subband error signals and to decompose the reference signal into a plurality of subband reference signals;
applying a respective subband secondary path transfer function to each subband reference signal to produce a plurality of filtered subband reference signals;
determining a subband gradient for each subband based on a respective filtered subband reference signal and a respective subband error signal;
determining an adaptive step size for updating subband adaptive filter weights for each of a plurality of subband adaptive filters;
updating a plurality of adaptive filter weights in each of the plurality of subband adaptive filters based on a respective adaptive step size and gradient; and
integrating the plurality of adaptive filter weights in each of the plurality of subband adaptive filters to produce updated weights for the adaptive weight filter, wherein the updated weights are applied to the adaptive weight filter to adjust the noise cancellation signal.

2. The method of claim 1, wherein the set of analysis filters includes a plurality of subband filters derived from a prototype filter using a window-based lowpass filter, each subband filter corresponding to a distinct frequency range within a vehicle cabin noise spectrum, and wherein the method further comprises selecting a window function for the prototype filter based on a predetermined frequency response characteristic for each subband.

3. The method of claim 1, wherein determining the adaptive step size for updating subband adaptive filter weights further comprises determining the adaptive step size based on a power contribution of the subband error signal and the filtered subband reference signal.

4. The method of claim 1, wherein applying the respective subband secondary path transfer function to each subband reference signal further comprises:
generating a white noise reference signal;
recording a residual signal at each of the plurality of error microphones resulting from emission of the white noise reference signal through the plurality of speakers;
decomposing the white noise reference signal and the residual signal into their respective subband components using the set of analysis filters;
calculating a subband gradient for each subband based on the decomposed subband components of the white noise reference signal and the residual signal; and
updating the subband secondary path transfer function for each subband based on the calculated subband gradient and a normalized step size, wherein the normalized step size is determined based on a power contribution of the decomposed subband components of the white noise reference signal and the residual signal.

5. The method of claim 1, wherein the reference sensor comprises at least one of an accelerometer configured to detect vibrations associated with the vehicle, a microphone configured to detect ambient noise outside the vehicle cabin, and a non-acoustic sensor configured to detect operational parameters of the vehicle indicative of noise generation.

6. A noise cancellation system for a vehicle, comprising:
a reference sensor configured to acquire a reference signal correlated to noise within a vehicle cabin;
an adaptive weight filter in electronic communication with the reference sensor, configured to apply an adaptive filtering process to the reference signal to produce a noise cancellation signal;
a plurality of speakers positioned within the vehicle cabin and in electronic communication with the adaptive weight filter, configured to emit the noise cancellation signal into the vehicle cabin;
a plurality of error microphones positioned within the vehicle cabin and configured to record a residual signal resulting from interaction of the emitted noise cancellation signal and the noise within the vehicle cabin; and
a signal processing unit in electronic communication with the reference sensor and the plurality of error microphones, wherein the signal processing unit comprises:
a non-transitory memory storing a set of subband filters, and instructions; and
a processor, wherein, when executing the instructions, the processor is configured to:
decompose the residual signal into a plurality of subband error signals and to decompose the reference signal into a plurality of subband reference signals;
convert the plurality of subband reference signals and the plurality of subband error signals into a plurality of subband reference signal blocks and a plurality of subband error signal blocks, respectively;
transform the plurality of subband error signal blocks and the plurality of subband reference signal blocks into a plurality of frequency-domain subband error signals and a plurality of frequency-domain subband reference signals, respectively;
apply a frequency-domain secondary path filter to the plurality of frequency-domain subband reference signals to produce a plurality of frequency-domain subband filtered reference signals;
determine a frequency-domain subband gradient for each subband based on a respective frequency-domain subband filtered reference signal and a corresponding frequency-domain subband error signal;
determine an adaptive step size for updating frequency-domain subband adaptive filter weights for each of a plurality of frequency-domain subband adaptive filters;
update a plurality of frequency-domain adaptive filter weights in each of the plurality of frequency-domain subband adaptive filters based on a respective frequency-domain adaptive step size and frequency-domain subband gradient; and
integrate the plurality of frequency-domain adaptive filter weights in each of the plurality of frequency-domain subband adaptive filters to produce updated weights for the adaptive weight filter in a time domain, wherein the updated weights are applied to the adaptive weight filter to adjust the noise cancellation signal.

7. The noise cancellation system of claim 6, wherein the signal processing unit is further configured to implement a subband overlap-save method to update the adaptive weight filter according to linear convolution to avoid a wrap-around effect caused by circular correlation in a frequency domain.

8. The noise cancellation system of claim 6, wherein the signal processing unit is further configured to multiply the plurality of frequency-domain subband reference signals with a secondary path filter in each subband to achieve secondary path filtering without requiring time-domain convolution.

9. The noise cancellation system of claim 6, wherein the signal processing unit is further configured to employ a frequency-domain subband flexible adaptation step size normalization method based on a power contribution of error microphone signals and reference signals to adjust the adaptive step size for each subband.

10. The noise cancellation system of claim 6, wherein the signal processing unit is further configured to perform an inverse Fast Fourier Transform (IFFT) on the plurality of frequency-domain adaptive filter weights to obtain the updated weights for the adaptive weight filter in the time domain.

11. A method comprising:
acquiring a reference signal using a reference sensor, wherein the reference signal is correlated with noise in a vehicle cabin;
emitting a noise cancellation signal using a plurality of speakers positioned in the vehicle cabin;
acquiring a residual signal from a plurality of error microphones positioned in the vehicle cabin;
transforming the reference signal and the residual signal into a frequency-domain reference signal and a frequency-domain residual signal, respectively, using a Fast Fourier Transform (FFT);
applying a secondary path filter to the frequency-domain reference signal to produce a frequency-domain filtered reference signal;
decomposing the frequency-domain filtered reference signal and the frequency-domain residual signal into a plurality of subband signals;
calculating a frequency-domain subband gradient for each subband based on the decomposed frequency-domain filtered reference signal and the frequency-domain residual signal;
updating a set of subband adaptive filter weights in a frequency domain based on the frequency-domain subband gradient and a frequency-domain subband flexible adaptation step size normalization;
transforming the updated set of subband adaptive filter weights from the frequency domain to a time domain using an Inverse Fast Fourier Transform (IFFT); and
emitting the noise cancellation signal based on the transformed subband adaptive filter weights to reduce noise in the vehicle cabin.

12. The method of claim 11, wherein acquiring of the reference signal includes detecting vibrations from a road surface using the reference sensor.

13. The method of claim 11, wherein the applying of the secondary path filter includes multiplying the frequency-domain reference signal with a frequency-domain estimated impulse response of a secondary path from the speakers to the error microphones.

14. The method of claim 11, wherein decomposing into a plurality of subband signals includes dividing a frequency spectrum into a predetermined number of frequency bands.

15. The method of claim 11, wherein calculating of the frequency-domain subband gradient for each subband includes performing a complex conjugate multiplication of the frequency-domain filtered reference signal and the frequency-domain residual signal.

16. The method of claim 11, wherein updating of the set of subband adaptive filter weights includes employing a leakage factor to prevent divergence of the adaptive filter weights.

17. The method of claim 11, wherein transforming of the updated set of subband adaptive filter weights includes applying an overlap-save method to mitigate wrap-around effects during the IFFT.

18. The method of claim 11, wherein the emitting of the noise cancellation signal based on the transformed subband adaptive filter weights includes adjusting a volume and phase of the noise cancellation signal for each speaker individually.

19. The method of claim 11, further comprising adjusting the frequency-domain subband flexible adaptation step size normalization based on a power contribution of the plurality of error microphones and reference signals to optimize the step size for each subband.

20. The method of claim 11, wherein transforming the reference signal and the residual signal into the frequency-domain reference signal and the frequency-domain residual signal further comprises:
forming a 2N block vector of the residual signal by appending N zero blocks to the residual signal; and
applying the Fast Fourier Transform (FFT) to the 2N block vector to obtain the frequency-domain residual signal, wherein N is a block size equal to a full length of an adaptive filter.
